(19) United States
(12) Patent Application Publication
(10) Pub. No.: US 2014/0156769 A1
(43) Pub. Date: Jun. 5, 2014

(54) SYSTEM AND METHOD FOR POSTING MESSAGE ON SOCIAL NETWORK WEBSITE THROUGH AN IMAGE

(71) Applicant: INSTITUTE FOR INFORMATION INDUSTRY, Taipei (TW)

(72) Inventors: Chun-Jhih WAN, Taipei City (TW); Ping-Che YANG, Kaohsiung City (TW); Tsun KU, Taipei City (TW); Wen-Tai HSIEH, Taipei City (TW); Hung-Sheng CHIU, New Taipei City (TW)

(21) Appl. No.: 13/938,361

(22) Filed: Jul. 10, 2013

(30) Foreign Application Priority Data
Dec. 4, 2012 (TW) 101145391

(51) Int. Cl. H04L 12/58

(52) U.S. Cl. CPC H04L 51/32
USPC 709/206

(57) ABSTRACT

A method of posting a message on a social network website through an image is provided. A database is provided for storing a plurality of comparison images and candidate information, wherein each of the candidate information corresponds to one of the comparison images and comprises at least one of a text and a picture corresponding to the corresponded comparison image. An image is received. The image is compared with the comparison images to select one comparison image as a selected image corresponding to the received image. The candidate information corresponding to the selected image is retrieved from the database. A message which can be posted on social network website corresponding to a user is generated according to the retrieved candidate information. The generated message is then transmitted to and posted on the social network website corresponding to the user.

### CROSS REFERENCE TO RELATED APPLICATIONS

This Application claims priority of Taiwan Patent Application No. 101145391, filed on Dec. 4, 2012, the entirety of which is incorporated by reference herein.

### BACKGROUND OF THE INVENTION

1. Field of the Invention

The present invention relates to a system and method for posting a message on a social network website through an image, and in particular, relates to a system and method capable of receiving an image, generating messages for a social network, and automatically posting the generated messages to a social website for a corresponding user.

2. Description of the Related Art

Recently, social networks and other network platforms are commonly used for word-of-mouth marketing. For example, current word-of-mouth marketing can be implemented by a user by posting messages related to a particular product/store on a social network website, or by posting messages or conducting a check-in step on a fan page for a particular product or store. According to the conventional method, the user is required to perform several steps, such as taking a picture, logging onto a social network website, or inputting a text, then a message (such as photographs, images, literal comments, etc.) is uploaded and posted onto a social network website. This conventional method is complicated, inconvenient, and time-consuming for the user. By this conventional method, the benefit of the advertisement may not be achieved for a store because the photograph or comments posted by the user may not be directly related to the store or a product of the store.

In order to log-in a social network website and to post messages conveniently for a user, some electronic devices (such as a smart phone, a tablet PC, a personal computer) can be used to set information for logging onto a social network website by a user in advance, and then a login process for the user can be performed automatically. If the user wants to post a message to his or her page on the social network website, he or she has to select a photograph or an image, input a text on the social network website. The user cannot accomplish the whole process by simply taking a picture or selecting an image.

In addition, in case of an interactive interface is preseted by a store(such as a linking address or display information), a user can post the preset linking address or display information to his or her page on a social network website by checking an option of ‘posting the preset data’ after the user logs in. The posted message, however, is preset by the store. All users checking the option of ‘posting the preset data’ get the same preset messages that are posted. Furthermore, the user cannot select or determine the photos/images to be posted, cannot provide his or her opinions or comments, and cannot provide photos/images to be posted. The posted message is nothing more than an advertisement, and is not word-of-mouth marketing such as comments or recommendations from satisfied customers.

Word-of-mouth marketing is usually implemented through messages based on a “landmark” or a “location”. For example, corresponding information and the geographical location of a store can be preset on the social website by the store. When the user reaches the geographical location of the store with his or her electronic device, the electronic device may confirm the user's geographical location by a positioning mechanism. Accordingly, the user may check-in the social website at the geographical location of the store, and the electronic device may automatically post the visitor history of the user to the store or the consumption records at the store. The geographical location of the user is primarily used to check-in the social website in the conventional way, but the electronic device cannot post a message associated with the store when the user has not reached the geographical location of the store yet.

Therefore, there is a need for a system and method for conducting word-of-mouth marketing through a social network website, which is capable of automatically posting a message in a more convenient and effective way. If available, the message can be automatically posted through an image in an intuitive and convenient way for the user. Using the method and system of the present invention, a personalized message related to a product, brand, or store can be posted based on photos or images of the corresponding product or store, without performing a complicated procedure, and without relying on a geographical location. In addition, by using the method and system of the present invention, a more effective word-of-mouth marketing result can be achieved via messages posted corresponding to a product, brand, or store.

### BRIEF SUMMARY OF THE INVENTION

A method and system of posting a message on a social network website through an image are provided. The present invention provides a system and a method for conducting word-of-mouth marketing through a social network website, which is capable of automatically posting a message in a more convenient and effective way, thus, the message can be automatically posted through an image in an intuitive and convenient way for the user.

In an exemplary embodiment, a system for posting a message on a social network website through an image is provided. The method comprises the following steps of: providing a database, configured to store a plurality of comparison images and candidate information, wherein each of the candidate information corresponds to one of the comparison images and comprises at least one of a text and a picture corresponding to the corresponded comparison image; receiving an image; comparing the image with the comparison images to select one comparison image as a selected image corresponding to the received image; retrieving the candidate information corresponding to the selected image from the database; and generating a message which can be posted on social network website corresponding to a user according to the retrieved candidate information, and transmitting the generated message to the social network website corresponding to the user for posting the message.

In another exemplary embodiment, a system for posting a message on a social network website through an image is provided. The system comprises: a database, configured to store a plurality of comparison images and candidate information, wherein each of the candidate information corresponds to one of the comparison images and comprises at least one of a text and a picture corresponding to the corresponded comparison image; an input interface, configured to receive an image; and a processor. The processor comprises: an image analyzing module, configured to compare the image with the comparison images to select one comparison image as a selected image corresponding to the received image; a message selecting module, configured to retrieve the candidate information corresponding to the selected image from the database; and a message posting module, configured to generate a message which can be posted on social network website corresponding to a user according to the retrieved candidate information, and transmitting the generated message to the social network website corresponding to the user for posting the message.

A non-transitory computer-readable storage medium is provided for storing a computer program providing a method for posting a message on a social network website through an image. The method comprises the following steps of: storing a plurality of comparison images and candidate information, wherein each of the candidate information corresponds to one of the comparison images and comprises at least one of a text and a picture corresponding to the corresponded comparison image; comparing the image with the comparison images to select one comparison image as a selected image corresponding to the received image; retrieving the candidate information corresponding to the selected image from the database; and generating a message which can be posted on social network website corresponding to a user according to the retrieved candidate information, and transmitting the generated message to the social network website corresponding to the user for posting the message.

Using the method and system of the present invention, a personalized message related to a product, brand, or store can be posted based on photos or images of the corresponding product or store, without performing a complicated procedure, and without relying on a geographical location. In addition, using the method and system of the present invention, more effective word-of-mouth marketing result can be achieved via messages posted corresponding to a product, brand, or store.

### BRIEF DESCRIPTION OF THE DRAWINGS

The present invention can be more fully understood by reading the subsequent detailed description and examples with references made to the accompanying drawings, wherein:

FIG. 1 is a schematic diagram of a system for posting a message on a social network website through an image according to an embodiment of the invention;

FIG. 2A is a flowchart illustrating the method for posting a message on a social network website through an image according to an embodiment of the invention; and

FIG. 2B is a flowchart illustrating the method for posting a message on a social network website through an image according to another embodiment of the invention.

### DETAILED DESCRIPTION OF THE INVENTION

A detailed description is given in the following embodiments with reference to the accompanying drawings.

The following description is of the best-contemplated mode of carrying out the invention. This description is made for the purpose of illustrating the general principles of the invention and should not be taken in a limiting sense. The scope of the invention is best determined by reference to the appended claims.

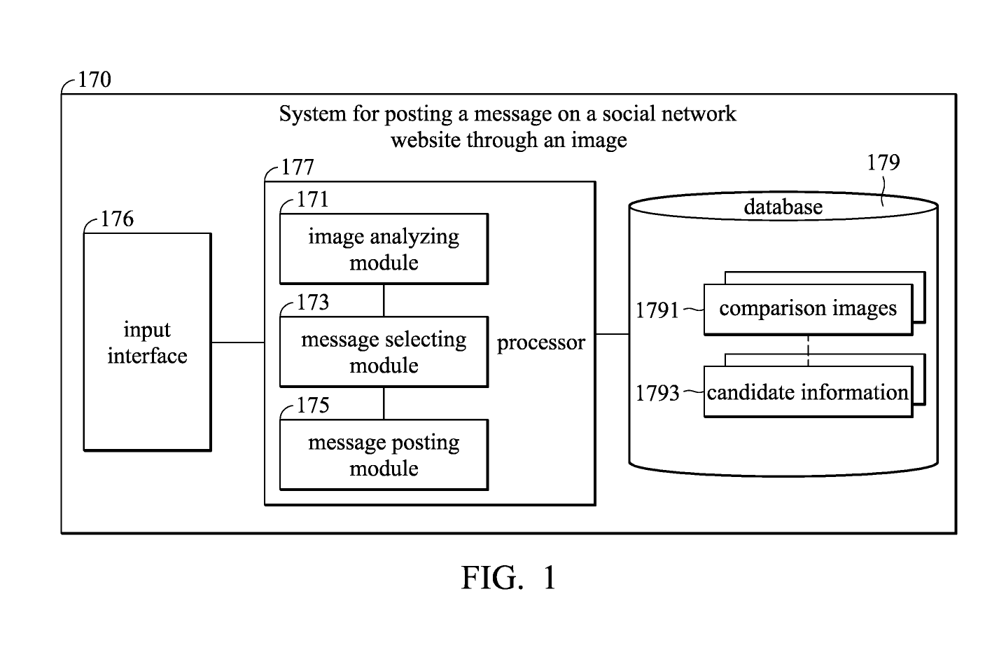

FIG. 1 is a schematic diagram of a system 170 for posting a message on a social network website through an image according to an embodiment of the invention. The system 170 at least comprises an input interface 176, a processor 177, and a database 179, wherein the processor 177 comprises an image analyzing module 171, a message selecting module 173, and a message posting module 175. According to an embodiment, the input interface 176 can be connected to an electronic device for a client in order to receive images from the electronic device. The electronic device can be implemented by, for example, a smart phone, a tablet PC, a laptop, or a personal computer. The processor 177 can be implemented by a server, a computer, or a processor which can be assembled at a general purpose computer. The database 179 can be implemented by the same server, or computer. In other embodiment, the database 179 can be implemented by another server, computer or a storage device. In this situation, the database 179 is connected to the processor 177 by cables (e.g. RS232 interface bus) or wired/wireless communications networks. The input interface 176 can be connected to the processor 177 by cables (e.g. RS232 interface bus) or wired/wireless communications networks. Furthermore, the electronic device for the client is capable of taking photograph and connecting to the Internet. The electronic device for the client can transmit a generated image file to a remote server or computer via a communication network, or can select one image file from image files stored in a storage unit in the electronic device for the client, and can transmit the selected image to the input interface 176 via a communication network. Furthermore, the image file can include the information, such as location information corresponding to a location where the photograph was taken, time information corresponding to a time at when the photograph was taken, or metadata of the image can record the location information or time information. In another embodiment, the image analyzing module 171, the message selecting module 173, and the message posting module 175 can be implemented by software modules read and executed by a processor of the server or the general computer.

The database 179 stores, in advance, a plurality of comparison images 1791, and the candidate information 1793 corresponding to each of the comparison images 1791, wherein the candidate information 1793 comprises at least one of a text and a picture corresponding to each of the comparison images 1791. The comparison images 1791 can be one of the following: an image of a trademark, an image of a product, and an image of a store signboard, an enterprise logo, an image of an enterprise name, or other graphic marks or images that can be used to identify a particular product, store, or enterprise. The candidate information 1793 can be a predetermined text, image, video or the combinations thereof. For example, the candidate information 1793 can be a description, valuation, slogan, poster, advertisement, or interesting expression pertaining to a product, store, or an enterprise. Furthermore, the database 179 can further store reward information or feedback information corresponding to the comparison images 1791, wherein the reward information can be used to reward a user, and the feedback information can be used to give a feedback to a user such as specific contents or specific information. For example, after a message is posted on the social network website by the user, rewards (such as an electronic coupon, goods voucher, reward points, or certificate) or information (such as activity information, goods information, or sale information) can be a provided to the user.

When the input interface 176 receives an image, for example, when an image file is transmitted from an electronic device for a client to the input interface 176, the image analyzing module 171 compares the received image with the comparison images 1791 stored in the database 179 to select one comparison image as a selected image corresponding to the received image. Furthermore, the image analyzing module 171 determines whether one part of the received image equal to one of the comparison images 1791 stored in the database 179, or determines whether one part of the received image is similar to one of the comparison images 1791 stored in the database 179. The image analyzing module 171 may be implemented by any existing image analysis technique, or any commercially available image analysis software. The image analyzing module 171 may compare the received image with one of the comparison images 1791 respectively, and may also separate the received image into several parts and then compare one of the separated parts with one of the comparison images 1791 respectively.

The message selecting module 173 retrieves at least one of the candidate information 1793 corresponding to the selected image from the database 179. For example, the image analyzing module 171 compares the image file transmitted from the electronic device for the client with one of the comparison images, and a result of the comparison is that a comparison image A(defined as the selected image A) appears in the image file. The message selecting module 173 retrieves candidate information X1˜Xn corresponding to the selected image A, wherein the candidate information X1˜Xn may be a text, a picture or image file, a video file, or web linkage, and then the message selecting module 173 further retrieves at least one candidate information, such as X1 and X2, from the candidate information X1˜Xn.

The message posting module 175 generates a message which can be posted on social network website corresponding to a user according to the retrieved candidate information, and transmits the generated message to the social network website corresponding to the user for posting the message. That is, the message posting module 175 automatically posts a message on the social network website according to a user ID on the social network website corresponding to the user and the retrieved text or image. The user ID can be stored in the electronic device, or correspond to the client. In addition, the message posting module 175 can first generate a message for a social network website for the user according to the retrieved candidate information, provide the generated message to the user and prompt the user to select, confirm, or modify the message, and then post the message to the social network website for the user. For example, after the message selecting module 173 retrieves candidate information X1 (such as an interesting expression related to the selected image A) and candidate information X2 (such as an image related to the selected image A), the message posting module 175 generates a message according to the candidate information X1 and candidate information X2 which corresponds to the user ID on the social network website and fits for data format of the social network website, transmits the message to the social network website (such as a social platform server, not shown in FIG. 1), and then posts the message for the corresponding user ID or user account.

The message posted by the message posting module 175 can be composed of the received image/photograph or the retrieved text/image. The message also can be generated by a user through modifying or editing the retrieved text/image. Sometimes, it is also possible that the posted message does not include the originally received image/photograph. In other words, the message posting module 175 can generate a message simply based on the retrieved text and image. That is, the candidate information X1 and candidate information X2 (i.e., retrieved text and image) can be directly used as the message posted by the message posting module 175. According to another exemplary embodiment, the message posting module 175 provides an operation interface which can be used to modify, edit, or change the retrieved candidate information X1 and candidate information X2 by the user, and the message after the user modifies, edits, or changes the retrieved candidate information X1 and candidate information X2 can be post to the social network website for the user. In addition, the posted message may include the received image, such as the image file transmitted from the electronic device. That means that, the message posting module 175 can refer to the received photograph/image to generate the message.

The message selecting module 173 can retrieve corresponding candidate information from plural candidate information via various ways. Some detail is provided as follows.

For example, the database 179 stores candidate information, wherein each of candidate information in the database corresponds to one of the comparison images and one of a plurality of geographical locations respectively. The geographical location information is implement by stored in the image file (such as geographical coordinates associated with the image, geographical location information of a portable device, or geographical location information input by the user through an interface). The message selecting module 173 retrieves the candidate information corresponding to the comparison image and the geographical location information from the candidate information corresponding to the comparison image which matches with the different geographical location information according to the geographical location information and the comparison image. For example, a store has a plurality of branches at different locations, wherein each of the branches corresponds to different candidate information. In other words, for a store A having branches at different locations, the database 179 stores a comparison image of store A (such as an image of a trademark representing the store A), as well as geographical location information and candidate information corresponding to each of the branches. When a user reaches one of the branches and photographs the comparison image of the store A using a mobile phone, the corresponding geographical location information can be obtained from the geographical coordinates associated with the image or geographical location information of the mobile phone. The message selecting module 173 retrieves the candidate information corresponding to the branch of the store A according to the comparison image of the store A and the geographical location information of the branch.

For another example, the database 179 stores candidate information, wherein each of the candidate information in the database corresponds to one of the comparison images and one of a plurality of time periods respectively. The time information is implement by corresponding to the image (such as time information specifying a time when the image was generated, a time when the image was received by a device, or a time input by a user through an operation interface) The message selecting module 173 retrieves candidate information corresponding to the comparison image and the time information from the candidate information corresponding to the comparison image which matches with the different time information according to the time information and the comparison image. For example, when a store B is going to sell or promote particular goods or services during different time periods, the database 179 stores comparison images of the store B (such as an image of a trademark representing the store B), as well as time information (time periods) and candidate information corresponding thereto. When a user transmits a photograph or image (such as a photograph or image of an comparison image of the store B) to the system, the corresponding time information can be obtained from the time stamp recorded in a corresponding image file or a timer of the mobile phone. The message selecting module 173 retrieves the candidate information corresponding to the store B according to the comparison image of the store B and the time information.

Social network websites, such as Facebook, Google+, Plurk, Twitter, Microblogging, Quazza.com, Myspace, Orkut, Kaixin, and personal websites, which help people connect based on shared interests or activities.

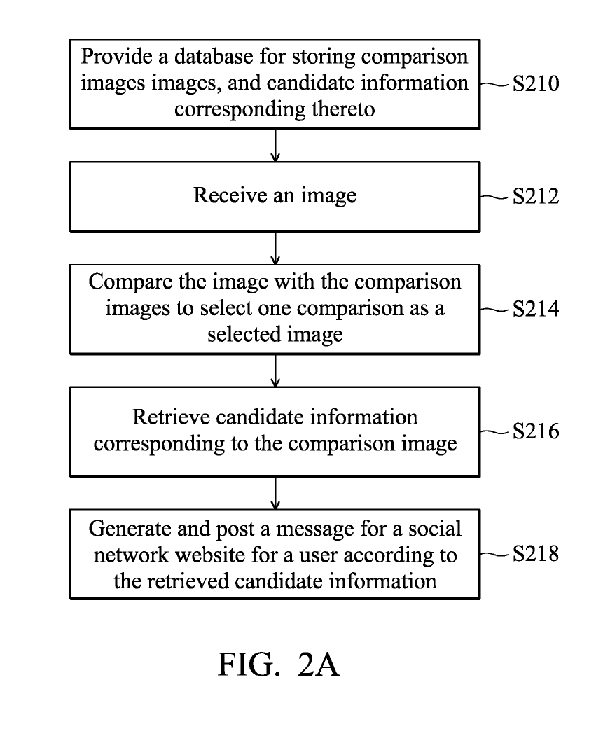

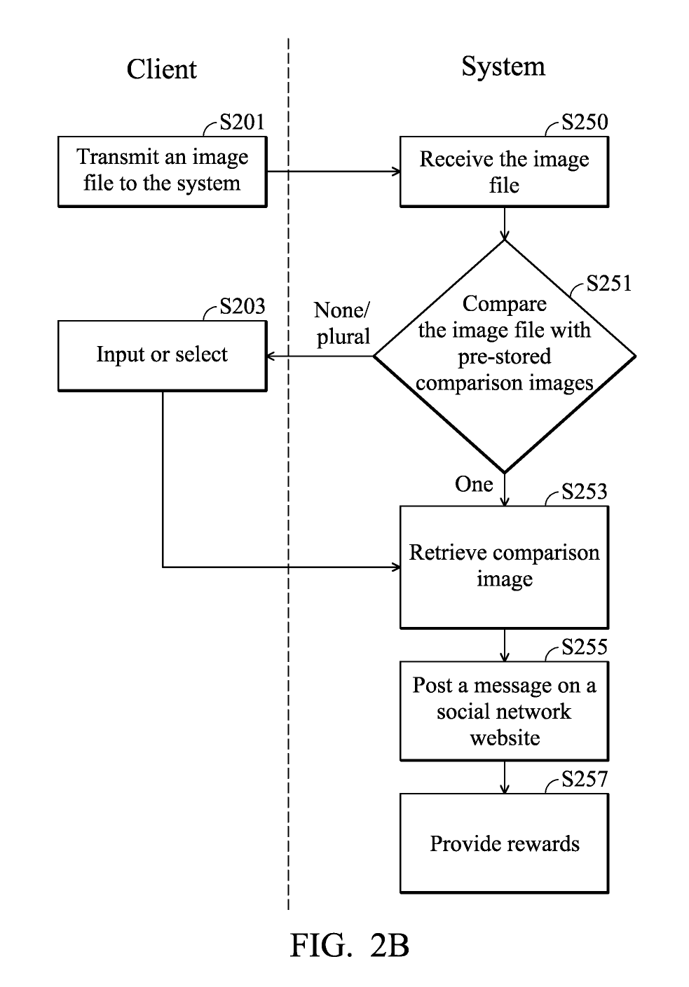

FIG. 2A is a flowchart illustrating the method for posting a message on a social network website through an image according to an embodiment of the invention. The illustrated method can be implemented by a processor equipped in a server or a general computer, or the system illustrated in FIG. 1.

In step S210, a database is provided. The database is configured to store a plurality of comparison images, and candidate information, wherein each of the candidate information corresponds to one of the comparison images and comprises at least one of a text and a picture corresponding to the corresponded comparison image.

In step S212, an image is received.

In step S214, the image is then compared with the comparison images in order to select one comparison image as a selected image corresponding to the received image.

In step S216, the candidate information corresponding to the selected image is retrieved from the database.

In step S218, a message for a social network website for a user is generated according to the retrieved candidate information, and the generated message is transmitted to the social network website corresponding to the user for posting the message.

FIG. 2B is a flowchart illustrating the method for posting a message on a social network website through an image according to another embodiment of the invention. This illustrated flowchart represents transaction processes between a client and a system. The illustrated processes can be implemented in the system shown in FIG. 1.

In this embodiment, the electronic device for a client is an electronic device capable of taking photographs, and the file of the photograph is utilized as the image specified in step S212. This embodiment is just an example, rather than a limitation for the invention.

The processor 177 is connected to the database 179. Thus, the processor 177 can access the comparison images 1791 and corresponding candidate information 1793, reward information or feedback information (not shown) stored in the database 179. The comparison image 1791 can be an image of a trademark, an image of a product, or an image of a signboard of a store. The candidate information 1793 can be a predetermined text, picture, video or combinations thereof. The database 179 can further store reward information or feedback information corresponding to the comparison images 1791.

In FIG. 2B, boxes on the left side represent steps performed on an electronic device for a client by a user, while boxes on the right side represent steps performed by a system for posting a message on a social network website.

In step S201, an image file is transmitted to the system for posting a message on a social network website through an image. The image file can represent a photograph taken instantly by the user, or a photograph stored in the electronic device for the client. The image file includes an image part and information part, wherein the information part includes geographical coordinates associated with the image, geographical location information of a portable device, or time information specifying a time when the image was generated.

Application programs can be a provided in order to facilitate user operation. For example, operations, such as uploading photographs, setting IP addresses for social network websites and setting user accounts for social network websites, can be automatically performed by the application programs. A user can set, in advance, his or her user account for at least one social network website upon installing the application programs. After that, a user can activate the installed application program, and can transmit photographs (instantly taken or previously stored) to the system for posting a message on a social network website through an image by one click, and then the system for posting a message on a social network website through an image performs the following steps automatically.

In step S250, the image file is received.

In step S251, the image file is compared with pre-stored comparison images 1791 in order to check whether the received image file matches with any one of the pre-stored comparison image 1791. The comparison performed in step S251 determines whether one part of the image file includes any one of the comparison images stored in the database, or determines whether one part of the image file is similar to one of the comparison images stored in the database.

Image identification techniques, such as openCV (http://www.intel.com/technology/computing/opencv), FastCV (https://developer.qualcomm.com/mobile-development/mobile-technologies/computer-vision-fastcv) and the like, can be utilized in step S251 to identify images in the image file or photograph, and to compare the image file with the pre-stored comparison image 1791.

Based on the results of the comparison, step S203 or step S253 is then performed.

If none of the pre-stored comparison images 1791 matches with the received image file, the method proceeds to step S203. In step S203, an operation interface is provided, enabling the user to mark one part of the image for identification, or present possible comparison images for further selection.

If more than one comparison image 1791 matches with the received image, the method can also proceed to step S203. In step S203, an operation interface is provided, presenting all the comparison images that match with the received image, and enabling the user to select one comparison image from the presented comparison images.

In step S253, one comparison image is retrieved from the comparison images 1791 stored in the database according to the comparison result obtained in step S251 or information input or selected by the user in step S203. According to the embodiment, the candidate information (such as text or picture) is set corresponding to each of the comparison images. Appropriate measures can be taken to select the candidate information from pre-stored candidate information. For example, the candidate information can be selected by random or in order, or can be selected according to other characteristics of the image file. In addition, selecting one of the candidate information corresponding to the selected image from the database can be selecting one or more than two of the candidate information.

As shown in FIG. 1, the database 179 can be configured to store candidate information, wherein each of candidate information in the database corresponds to one of the comparison images and one of a plurality of geographical locations respectively or corresponds to one of the comparison images and one of a plurality of time information respectively. In step S250, the image file, as well as the geographical location information and/or time information corresponding to the image file can be received. In the step S253, candidate information corresponding to the comparison image and the geographical location information and/or the time information can be retrieved according to the comparison image and the geographical location information and/or the time information.

In step S255, a message for a social network website for a user is generated according to the retrieved candidate information, and the generated message is transmitted to the social network website for posting the message. The generated message for a social network website for a user includes one of the following: the image file (photograph), a part of the image file (photograph), the selected image, and an image of a product corresponding to the selected image.

The social network website can be a social website or a personal website, such as a fan page on Facebook, personal profile space (wall) for a particular user, or a webpage of a store, a product or a brand.

The IP address of the social network website and account information used for posting messages can be set via the application software, and also can be input by the user (not shown in FIG. 2A and FIG. 2B). Thus, the system automatically performs the step of posting the generated message upon transmission of the image file.

In step S257, after the message is posted on the social network website for the user, a reward can be a provided to the user according to pre-stored reward information corresponding to each of the comparison images 1791. For example, the product presented in the image can be offered at a special price, or a coupon for the product or store can be provided. In other words, according to the present invention, a reward is provided to the user according to the reward information after the message is posted on the social network website for the user.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

According to another embodiment, the present invention can be implemented by a computer-readable storage medium. An electronic device reads program codes stored in the computer-readable storage medium, and performs a method for posting a message on a social network website through an image according to the program codes. When the program code is loaded into and executed by a machine, such as a computer, the machine thereby becomes an apparatus for practicing the method. The method includes: storing, in advance, a plurality of comparison images, and the candidate information corresponding to each of the comparison images, wherein the candidate information comprises a text and/or a picture corresponding to each of the comparison images; comparing an image with the comparison images to determine one of the comparison images which matches with the received image; retrieving the candidate information corresponding to the comparison image which matches with the image from the database according to a result of the comparison; and generating a message for a social network website for a user according to the retrieved candidate information, and transmitting the generated message to the social network website for posting the message for the user.

As described, using the system and method for posting a message on a social network website through an image, when a user takes a picture of a product, signboard of a store or a trademark, an electronic device for a client generates messages according to the picture, and transmits and posts the generated messages to social network website(s) for the user. Accordingly, after taking or selecting the picture, a simple operation is required for the user to generate the messages corresponding to the picture and post them automatically. The generated message can be one of the following: the image file (photograph), a part of the image file (photograph), the comparison image, and an image of a product corresponding to the comparison image. For a user, using the method and system of the present invention, word-of-mouth marketing can be implemented, by posting messages or conducting a check-in step on a fan page for a particular product or store, without complicated user operations, and rewards can be obtained thereby. Also, proper advertising for a store can be achieved because the photograph or comments posted by a user is directly related to the store or a product of the store. In addition, rewards to the user can further promote word-of-mouth marketing.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for posting a message on a social network website through an image, comprising the steps of:
providing a database, configured to store a plurality of comparison images and candidate information, wherein each of the candidate information corresponds to one of the comparison images and comprises at least one of a text and a picture corresponding to the corresponded comparison image;
receiving an image;
comparing the image with the comparison images to select one comparison image as a selected image corresponding to the received image;
retrieving the candidate information corresponding to the selected image from the database; and
generating a message which can be posted on social network website corresponding to a user according to the retrieved candidate information, and transmitting the generated message to the social network website corresponding to the user for posting the message.

2. The method as claimed in claim 1, wherein the comparison image comprises at least one of an image of a trademark, an image of a product, and an image of a store signboard.

3. The method as claimed in claim 2, wherein each of candidate information in the database corresponds to one of the comparison images and one of a plurality of geographical locations respectively, and the method further comprises the step of:
receiving geographical location information corresponding to the image; and
in the step of retrieving the candidate information corresponding to the selected image, the retrieving is performed according to the geographical location information corresponding to the image, the comparison image, and the candidate information in the database.

4. The method as claimed in claim 1, wherein each of the candidate information in the database corresponds to one of the comparison images and one of a plurality of time periods respectively, and the method further comprises the step of:
receiving time information corresponding to the image, wherein the time information is one of a time when the image was generated, a time when the image was received by a device, and a time input by the user through an operation interface; and
in the step of retrieving the candidate information corresponding to the selected image, the retrieving is performed according to the time information corresponding to the image, the comparison image, and the candidate information in the database.

5. The method as claimed in claim 1, wherein the step of comparing the image with the comparison images is performed by comparing one part of the image with one of the comparison images stored in the database respectively, or by determining whether one part of the image is similar to one of the comparison images stored in the database.

6. The method as claimed in claim 1, wherein the database further stores reward information for each of the comparison images, and the method further comprises the step of:
providing a reward to the user according to the reward information after the message is posted on the social network website corresponding to the user.

7. The method as claimed in claim 1, wherein the step of retrieving the candidate information corresponding to the selected image is selecting one of the candidate information, or selecting more than two of the candidate information.

8. The method as claimed in claim 1, wherein the message generated to be posted on the social network website is one of the image, a part of the image, the comparison image, and a product image corresponding to the comparison image.

9. A system for posting a message on a social network website through an image, comprising:
a database, configured to store a plurality of comparison images and candidate information, wherein each of the candidate information corresponds to one of the comparison images and comprises at least one of a text and a picture corresponding to the corresponded comparison image;
an input interface, configured to receive an image; and
a processor, comprising:
an image analyzing module, configured to compare the image with the comparison images to select one comparison image as a selected image corresponding to the received image;
a message selecting module, configured to retrieve the candidate information corresponding to the selected image from the database; and
a message posting module, configured to generate a message which can be posted on social network website corresponding to a user according to the retrieved candidate information, and transmitting the generated message to the social network website corresponding to the user for posting the message.

10. The system as claimed in claim 9, wherein the comparison image comprises at least one of an image of a trademark, an image of a product, and an image of a store signboard.

11. The system as claimed in claim 10, wherein:
each of candidate information in the database corresponds to one of the comparison images and one of a plurality of geographical locations respectively;
the input interface further receives geographical location information corresponding to the image; and
the message selecting module further performs the retrieving according to the geographical location information corresponding to the image, the comparison image, and the candidate information in the database.

12. The system as claimed in claim 9, wherein:
each of the candidate information in the database corresponds to one of the comparison images and one of a plurality of time periods respectively;
the input interface further receives time information corresponding to the image, wherein the time information is one of a time when the image was generated, a time when the image was received by a device, and a time input by the user through an operation interface; and
the message selecting module further performs the retrieving according to the time information corresponding to the image, the comparison image, and the candidate information in the database.

13. The system as claimed in claim 9, wherein the image analyzing module compares one part of the image with one of the comparison images stored in the database respectively, or determines whether one part of the image is similar to one of the comparison images stored in the database.

14. The system as claimed in claim 9, wherein the database further stores reward information for each of the comparison images, and the system further comprises:
a reward module providing a reward to the user according to the reward information after the message is posted on the social network website corresponding to the user.

15. The system as claimed in claim 9, wherein the message selecting module selects one of the candidate information, or selects more than two of the candidate information.

16. The system as claimed in claim 9, wherein the message posting module generates the message to be posted on the social network website, wherein the message generated to be posted on the social network website is one of the image, a part of the image, the comparison image, and a product image corresponding to the comparison image.

17. A non-transitory computer-readable storage medium for storing a computer program providing a method for posting a message on a social network website through an image, the method comprising:
storing a plurality of comparison images and candidate information, wherein each of the candidate information corresponds to one of the comparison images and comprises at least one of a text and a picture corresponding to the corresponded comparison image ;
comparing the image with the comparison images to select one comparison image as a selected image corresponding to the received image;
retrieving the candidate information corresponding to the selected image from the database; and
generating a message which can be posted on social network website corresponding to a user according to the retrieved candidate information, and transmitting the generated message to the social network website corresponding to the user for posting the message.
